(19) United States
(12) Patent Application Publication
(10) Pub. No.: US 2026/0058206 A1
(43) Pub. Date: Feb. 26, 2026

(54) ELECTROLYTE FOR LITHIUM-SULFUR SECONDARY BATTERY, AND LITHIUM-SULFUR SECONDARY BATTERY COMPRISING SAME

(71) Applicant: LG ENERGY SOLUTION, LTD., Seoul (KR)

(72) Inventors: In-Tae PARK, Daejeon (KR); Seong-Hyo PARK, Daejeon (KR); Myeong-Jun SONG, Daejeon (KR); Chang-Hoon LEE, Daejeon (KR); Hyun-Soo LEE, Daejeon (KR)

(21) Appl. No.: 19/105,794

(22) PCT Filed: Dec. 20, 2023
(86) PCT No.: PCT/KR2023/021170

§ 371 Date: Feb. 21, 2025

(30) Foreign Application Priority Data
Dec. 23, 2022 (KR) 10-2022-0183762

(51) Int. Cl. H01M 10/0568; H01M 10/052; H01M 10/0569

(52) U.S. Cl. CPC H01M 10/0568; H01M 10/052; H01M 10/0569; H01M 2300/0034; H01M 2300/0037

(57) ABSTRACT

Aspects of the present disclosure relates to an electrolyte for a lithium-sulfur secondary battery and a lithium-sulfur secondary battery comprising the same, and provides a lithium-sulfur secondary battery with improved life characteristics that can be imparted by adjusting a solvent, a nonsolvent and a lithium salt included in the electrolyte to specific conditions.

### CROSS-REFERENCE TO RELATED APPLICATIONS

The present application is a National Phase entry pursuant to 35 U.S.C. § 371 of International Application No. PCT/KR2023/021170, filed Dec. 20, 2023, and claims the benefit of and priority to Korean Patent Application No. 10-2022-0183762 filed on Dec. 23, 2022 in the Republic of Korea, the disclosures of each of which are incorporated herein by reference in their entireties for all purposes as if fully set forth herein.

### TECHNICAL FIELD

The present disclosure relates to an electrolyte for a lithium-sulfur secondary battery and a lithium-sulfur secondary battery comprising the same.

### BACKGROUND

The existing lithium-sulfur (Li—S) batteries using catholyte systems do not make good use of high theoretical discharge capacity (1675 mAh/g) of sulfur because they rely on liquid phase reaction (catholyte type) through the production of Li₂S_{X}, an intermediate product of polysulfide, and exhibit a decline in life characteristics due to polysulfide dissolution induced degradation. To solve this problem, a LiNO₃ additive is used, but additive loss impedes long life characteristics of lithium sulfur batteries.

Recently, sparingly solvating electrolyte (SSE) systems have been suggested to suppress polysulfide dissolution and it was confirmed that electrolytes free of predetermined additives achieve normal operation without delayed charging. However, the life is still short, so there is a need to improve life characteristics.

To achieve high energy density of 400 Wh/kg or more, 600 Wh/L or more, there is a need for an electrolyte system for a lithium-sulfur secondary battery that can operate at 4.0 mAh/cm² or more and the porosity of 60 vol % or more and improve life characteristics.

The background description provided herein is for the purpose of generally presenting context of the disclosure. Unless otherwise indicated herein, the materials described in this section are not prior art to the claims in this application and are not admitted to be prior art, or suggestions of the prior art, by inclusion in this section.

### SUMMARY

Aspects of the present disclosure are designed at least in part to address the above-described problem and therefore aspects of the present disclosure are directed to providing an electrolyte for a lithium-sulfur secondary battery with high energy density and improved life characteristics and a lithium-sulfur secondary battery comprising the same.

It will be readily understood that these and other objectives and advantages of the according to aspects of the present disclosure may be realized by the means or methods set forth in the appended claims and a combination thereof.

According to certain embodiments, it has been found that the above-described problem can be addressed through an electrolyte for a lithium-sulfur secondary battery as described below and a lithium-sulfur secondary battery including the same.

According to a first embodiment, aspects of the present disclosure relate to the electrolyte for the lithium-sulfur secondary battery including a solvent, a nonsolvent and lithium salts including at least two lithium salt types, wherein the lithium salts include LiI,
wherein a Solvent Volume Ratio (SVR) factor value of the solvent and the nonsolvent is from 0.2 to 0.7, and the SVR factor value is represented by the following Equation 1, and
wherein a Molar mass Ratio (MR) factor value of the solvent and the lithium salts is from 0.75 to 1.85, and the MR factor value is represented by the following Equation 2,

$$S V R factor = volume of the solvent \div volume of the nonsolvent \qquad [ Equation 1 ]$$

$$M R factor = Number of moles of the solvent \div ( Number of moles of the lithium salts excluding the LiI ) \qquad [ Equation 2 ]$$

According to a second embodiment, aspects of the present disclosure relate to the electrolyte for the lithium-sulfur secondary battery of the first embodiment, wherein the SVR factor value is from 0.3 to 0.65.

According to a third embodiment, aspects of the present disclosure relate to the electrolyte for the lithium-sulfur secondary battery according to the first or second embodiment, wherein the MR factor value is from 1.0 to 1.75.

According to a fourth embodiment, aspects of the present disclosure relate to the electrolyte for the lithium-sulfur secondary battery according to any one of the first to third embodiments, wherein the solvent has a solubility of 0.1M or more for the lithium salts, and the nonsolvent has a solubility of less than 0.1M for the lithium salts.

According to a fifth embodiment, aspects of the present disclosure relate to the electrolyte for the lithium-sulfur secondary battery according to any one of the first to fourth embodiments, wherein the solvent includes a linear ether, a cyclic ether or a mixture thereof.

According to a sixth embodiment, aspects of the present disclosure relate to the electrolyte for the lithium-sulfur secondary battery according to any one of the first to fifth embodiments, wherein the solvent includes a mixture of a linear ether and a cyclic ether.

According to a seventh embodiment, aspects of the present disclosure relate to the electrolyte for the lithium-sulfur secondary battery according to any one of the first to sixth embodiments, wherein the nonsolvent includes a fluorinated ether.

According to an eighth embodiment, aspects of the present disclosure relate to the electrolyte for the lithium-sulfur secondary battery according to any one of the first to seventh embodiments, wherein the lithium salts include lithium bis(fluorosulfonyl)imide (LiFSI), lithium bis(trifluoromethanesulfonyl)imide (LiTFSI) and LiI.

According to a ninth embodiment, aspects of the present disclosure relate to the electrolyte for the lithium-sulfur secondary battery according to any one of the first to eighth embodiments, wherein an amount of the LiI is from 0.1 to 3.0 parts by weight based on total 100 parts by weight of the electrolyte for the lithium-sulfur secondary battery.

According to a tenth embodiment, aspects of the present disclosure relates to the electrolyte for the lithium-sulfur secondary battery according to any one of the first to ninth embodiments, wherein the amount of the LiI is from 0.35 to 15 parts by weight based on total 100 parts by weight of the lithium salts.

According to an eleventh embodiment, aspects of the present disclosure relate to the electrolyte for the lithium-sulfur secondary battery according to any one of the first to tenth embodiments, wherein the electrolyte for the lithium-sulfur secondary battery does not include any of a nitrate-based compound or a nitrite-based compound.

According to a twelfth embodiment, aspects of the present disclosure relate to the lithium-sulfur secondary battery including a negative electrode: a positive electrode: a separator; and the electrolyte according to any one of the first to eleventh embodiments.

The electrolyte for the lithium-sulfur secondary battery according to aspects of the present disclosure and the lithium-sulfur secondary battery comprising the same may improve life characteristics by adjusting the solvent, the nonsolvent and the lithium salt included in the electrolyte to specific conditions.

### DETAILED DESCRIPTION

Hereinafter, aspects of the present disclosure will be described in more detail.

It should be understood that the terms or words used in the specification and the appended claims should not be construed as limited to general and dictionary meanings, but rather interpreted based on the meanings and concepts corresponding to the technical aspect of the present disclosure on the basis of the principle that the inventor is allowed to define terms appropriately for the best explanation.

The term “comprise” or “include” when used in this specification, specifies the presence of stated elements, but does not preclude the presence or addition of one or more other elements, unless the context clearly indicates otherwise.

Throughout the specification, “A and/or B” refers to either A or B or both.

In the present disclosure, “specific surface area” is measured by the Brunauer, Emmett and Teller (BET) method, and specifically, it may be calculated from the adsorption amount of nitrogen gas under the liquid nitrogen temperature (77K) using BEL Japan's BELSORP-mino II.

The term “polysulfide” as used herein is the concept that covers “polysulfide ion (Sₓ²⁻, x=8, 6, 4, 2)” and “lithium polysulfide (Li₂Sₓ or LiSₓ⁻, x=8, 6, 4, 2)”.

The term “composite” as used herein refers to a material with physically·chemically different phases and more effective functions, formed by combining two or more materials.

The term “porosity” as used herein refers to the ratio of the volume of pores to the total volume of a structure, as indicated in %, and may be used interchangeably with the term pore ratio, void ratio, etc.

Aspects of the present disclosure relate to an electrolyte for a lithium-sulfur secondary battery and a lithium-sulfur secondary battery including the same.

The electrolyte for the lithium-sulfur secondary battery according to an aspect of the present disclosure includes a solvent, a nonsolvent and lithium salts that include at least two lithium salt types, where the lithium salts include LiI, a Solvent Volume Ratio (SVR) factor value of the solvent and the nonsolvent is from 0.2 to 0.7, and a Molar mass Ratio (MR) factor value of the solvent and the lithium salts is from 0.75 to 1.85.

Hereinafter, embodiments and aspects of each component will be described in detail.

The lithium-sulfur secondary battery, which is a type of secondary battery, is attracting attention as a next-generation secondary battery due to its advantages: high discharge capacity and theoretical energy density, abundance and low price of sulfur used as a positive electrode active material, leading to a reduction in manufacturing cost of the battery, and eco-friendliness.

Meanwhile, polysulfide dissolution suppression can be a challenge in lithium-sulfur secondary batteries, and to this end, a sparingly solvating electrolyte (SSE) system has been developed. However, because the SSE system may induce solid phase reactions, it can be difficult to maintain reversible reaction of the positive/negative electrode active material, so that short battery life is still an unsolved problem.

according to certain aspects, it has been discovered that a predetermined electrolyte system for improving the life characteristics can be provided by using an SSE system which excludes a nitrile-based electrolyte solvent that may be critical to the life of lithium-sulfur batteries, and using a solvent, a nonsolvent and a lithium salt satisfying predetermined conditions, to solve the problem with degradation of the lithium negative electrode, gas generation in the battery or failure to maintain reversible reaction of the positive/negative electrode active material.

According to certain aspects, the SVR factor value of the solvent and the nonsolvent is from 0.2 to 0.7, as represented by Equation 1 below.

$$S V R factor = volume ( A ) of the solvent \div volume ( B ) of the nonsolvent \qquad [ Equation 1 ]$$

In the above Equation 1, the volume of the solvent and the volume of the nonsolvent refer to the volume of the solvent and the nonsolvent in the electrolyte, respectively, and the SVR factor value is dimensionless.

The SVR factor value may be from 0.2 to 0.7, and according to an embodiment of the present disclosure, the SVR factor value may be in a range between 0.3 and 0.65 or between 0.4 and 0.5. When the SVR factor value is outside of the aforementioned range, it may be difficult to effectively improve the performance. In particular, when the SVR factor value is larger than 0.7, excess lithium polysulfides may dissolve in the electrolyte, and when the SVR factor is less than 0.2, solubility of the lithium salt may be so low that it may be impossible to produce the electrolyte, or even though the electrolyte is produced, the secondary battery may fail to normally operate due to low ionic conductivity of the electrolyte.

According to aspects of the present disclosure, the solvent may have solubility of 0.1M or more for the lithium salt, and the nonsolvent may have solubility of less than 0.1M for the lithium salt. Specifically, the solvent may have solubility of 0.1M or more for an imide-based lithium salt such as LiTFSI, LiFSI, LiTF, etc., and the nonsolvent may have solubility of less than 0.1M for the lithium salt.

The solvent and the nonsolvent may include, without limitation, any type of solvent and nonsolvent that are commonly used in electrolytes of secondary batteries, and meet the solubility condition for the lithium salt and the SVR factor value described above.

In an embodiment of the present disclosure, the solvent may include a linear ether, a cyclic ether or a mixture thereof.

For example, the solvent may include linear ethers such as dimethyl ether, diethyl ether, dipropyl ether, dibutyl ether, diisobutyl ether, ethylmethyl ether, ethylpropyl ether, ethyltertbutyl ether, dimethoxymethane, trimethoxymethane, dimethoxyethane, diethoxyethane, dimethoxypropane, diethyleneglycol dimethylether, diethyleneglycol diethylether, triethyleneglycol dimethylether, tetraethyleneglycol dimethylether, ethyleneglycol divinylether, diethyleneglycol divinylether, triethyleneglycol divinylether, dipropylene glycol dimethylene ether, butylene glycol ether, diethyleneglycol ethylmethylether, diethyleneglycol isopropylmethylether, diethyleneglycol butylmethylether, diethyleneglycol tertbutylethylether, ethyleneglycol ethylmethylether, etc.: cyclic ethers such as dioxolane, methyldioxolane, dimethyldioxolane, vinyldioxolane, methoxydioxolane, ethylmethyldioxolane, oxane, dioxane, trioxane, tetrahydrofuran, 2-methyltetrahydrofuran, dimethyltetrahydrofuran, dimethoxytetrahydrofuran, ethoxytetrahydrofuran, dihydropyran, tetrahydropyran, furan, 2-methylfuran, etc.; or a mixture thereof.

For example, the solvent may include a mixture of a linear ether and a cyclic ether. Specific examples may include dimethoxyethane and tetrahydrofuran, dimethoxyethane and 2-methyltetrahydrofuran, dimethoxyethane and tetrahydropyran, ethyleneglycol diethylether and tetrahydrofuran, or ethyleneglycol diethylether and methyltetrahydrofuran. The inclusion of the mixture of the linear ether and the cyclic ether can have a beneficial effect on stabilization of the negative electrode and gas generation suppression.

In an embodiment of the present disclosure, the nonsolvent may include a fluorinated ether. For example, the nonsolvent may include fluorinated ether compounds, such as 1, 1,2,2-tetrafluoroethyl 2,2,3,3-tetrafluoropropylether (TTE), bis(fluoromethyl) ether, 2-fluoromethylether, bis(2,2,2-trifluoroethyl) ether, propyl 1,1,2,2-tetrafluoroethylether, isopropyl 1,1,2,2-tetrafluoroethylether, 1,1,2,2-tetrafluoroethylisobutylether, 1,1,2,3,3,3-hexafluoropropylethylether, 1H, 1H,2′H,3H-decafluorodipropylether, 1H, 1H, 2′H-perfluorodipropylether, difluoromethyl 2,2,2-trifluoroethyl ether, 1,2,2,2-tetrafluoroethyl trifluoromethyl ether, 1, 1,2,3,3,3-hexafluoropropyl difluoromethyl ether, pentafluoroethyl 2,2,2-trifluoroethyl ether, 1H, 1H, 2′H-perfluorodipropyl ether, etc.

According to aspects of the present disclosure, the electrolyte for the lithium-sulfur secondary battery can include lithium salts that include at least two lithium salt types, and where the lithium salts include LiI. That is, the lithium salts may include LiI and at least one other type of lithium salt.

The other lithium salt may include, without limitation, any compound that provides lithium ions used in lithium secondary batteries. For example, the other lithium salt may include imide-based lithium salts, LiPF₆, LiClO₄, LiAsF₆, LiBF₄, LiSbF₆, LiAl0₄, LiAlCl₄, LiCH₃CO₂, LiCF₃SO₃, LiCAF₉SO₃, LiCl, LiBr, or LiB(C₂O₄)₂.

Because the imide-based lithium salt is chemically stable and dissolves in an organic solvent well, when the imide-based lithium salt is used as the lithium salt of the lithium-sulfur secondary battery, it may be possible to stably maintain the capacity of the lithium-sulfur battery and improve the battery life. Additionally, when two or more imide-based lithium salts, as opposed to a single lithium salt, are used, stability between the lithium negative electrode and the electrolyte solution may improve, making it possible to manufacture the secondary battery having long life.

For example, the imide-based lithium salt may include lithium bis(trifluoromethanesulfonyl)imide (LiTFSI), lithium bis(fluorosulfonyl)imide (LiFSI), lithium bis(perfluoroethylsulfonyl)imide (LiBETI), etc.

According to one embodiment, the lithium salts included in the electrolyte for the lithium-sulfur secondary battery according to an embodiment of the present disclosure may include three different lithium salt types.

Specifically, the lithium salts included in the electrolyte for the lithium-sulfur secondary battery according to an embodiment of the present disclosure may include lithium bis(fluorosulfonyl)imide (LiFSI), lithium bis(trifluoromethanesulfonyl)imide (LiTFSI) and LiI. When the above-described combination of lithium salts is included, it may be possible to reduce side reaction with the negative electrode and increase reversibility of sulfur.

In this instance, the amount of the LiI may be from 0.1 to 3.0 parts by weight, or from 0.1 to 2 parts by weight based on 100 parts by weight of the electrolyte for the lithium-sulfur secondary battery. Alternatively, the amount of the LiI may be from 0.35 to 15 parts by weight based on 100 parts by weight of all lithium salts. When the amount of the LiI is within the aforementioned range, it may be possible to increase reversibility of sulfur, thereby improving the battery life.

The molar concentration of all lithium salts may be in a range between 0.1 and 5.0M, or between 0.1 and 3.0M. Within the aforementioned range, the electrolyte may have optimum conductivity and viscosity and exhibit the outstanding electrolyte performance, contributing to the effective movement of lithium ions.

The Molar mass Ratio (MR) factor value of the solvent and the lithium salts is from 0.75 to 1.85, as represented by Equation 2 below.

$$M R factor = number of moles of the solvent \div number of moles of lithium salts excluding LiI \qquad [ Equation 2 ]$$

In the above Equation 2, the number of moles of lithium salts excluding LiI refers to the sum of the number of moles of lithium salts excluding LiI from all lithium salts included in the electrolyte, and the number of moles of the solvent refers to the sum of the number of moles of all solvents excluding the nonsolvent included in the electrolyte. The MR factor value is dimensionless.

The MR factor value may be from 0.75 to 1.85, and according to an embodiment of the present disclosure, the MR factor value may be in a range between 1.0 and 1.75 or between 1.0 and 1.7. When the MR factor value satisfies the aforementioned range, it may be possible to suppress dissolution of lithium polysulfide and increase ionic conductivity of the electrolyte, thereby improving the life of the secondary battery.

For example, a method for calculating the SVR factor value and the MR factor value based on Example 1 specified in Table 1 below will be described.

First, Example 1 includes 2MeTHF (solvent 1): EGDEE (solvent 2): TTE (nonsolvent)=2:1:7 (volume ratio), so the SVR factor value is calculated as (2+1)/7=0.43.

Subsequently, Example 1 includes LiTFSI, LiFSI and LiI as the lithium salt, but in the calculation of the MR factor value, LiI is excluded when calculating the number of moles of all lithium salts. On the basis of production of 1 kg of electrolyte, 0.66 mol of 2MeTHF (molar mass: 86.134), 0.73 mol of EGDEE (molar mass: 118.18), 0.71 mol of LiTFSI (molar mass: 287) and 0.23 mol of LiFSI (molar mass 187) are included, so the MR factor value is calculated as (0.66+0.73)/(0.71+0.23)=1.48.

That is, it was confirmed that Example 1 satisfies the aforementioned ranges of SVR factor value and MR factor value according to aspects of the present disclosure and may show outstanding performance in the life evaluation results.

The electrolyte for the lithium-sulfur secondary battery according to an embodiment of the present disclosure does not include any of a nitrate-based compound or a nitrite-based compound.

Nitrate- and/or nitrite-based compounds are generally used as an electrolyte additive, to form a stable coating on the lithium electrode and improve charge and discharge efficiency, but can be impossible to increase the life characteristics due to loss. In this circumstance, it has been discovered that the life improvement effect can be achieved without including the nitrate- and/or nitrite-based compounds commonly used as additives.

The nitrate- or nitrite-based compound is not limited to a particular type in the present disclosure, but may include inorganic nitrate or nitrite compounds such as lithium nitrate (LiNO3), potassium nitrate (KNO3), cesium nitrate (CsNO3), barium nitrate (Ba(NO3)2), ammonium nitrate (NH4NO3), lithium nitrite (LiNO2), potassium nitrite (KNO2), cesium nitrite (CsNO2), ammonium nitrite (NH4NO2), etc.; organic nitrate or nitrite compounds such as methyl nitrate, dialkyl imidazolium nitrate, guanidine nitrate, imidazolium nitrate, pyridinium nitrate, ethyl nitrite, propylnitrite, butyl nitrite, pentyl nitrite, octyl nitrite, etc.: organic nitro compounds such as nitromethane, nitropropane, nitrobutane, nitrobenzene, dinitrobenzene, nitropyridine, dinitropyridine, nitrotoluene, dinitrotoluene, etc., or a combination thereof. Specifically, the additive may not include lithium nitrate (LiNO3).

Meanwhile, according to certain embodiments, the electrolyte may further include another additive to improve charge and discharge characteristics, flame retardancy, etc. Examples of the additive may include pyridine, triethylphosphite, triethanolamine, cyclic ether, ethylene diamine, n-glyme, hexa phosphoric acid triamide, nitrobenzene derivatives, sulfur, quinone imine dyes, N-substituted oxazolidinone, N,N-substituted imidazolidine, ethylene glycol dialkyl ether, ammonium salts, pyrrole, 2-methoxy ethanol, aluminum trichloride, fluoroethylene carbonate (FEC), propene sultone (PRS), vinylene carbonate (VC), etc.

A method for manufacturing the electrolyte for the lithium-sulfur secondary battery according to aspects of the present disclosure is not particularly limited in the present disclosure, but the electrolyte may be manufactured by any method well known in the art.

In an embodiment of the present disclosure, there is provided a lithium-sulfur secondary battery including a negative electrode: a positive electrode: a separator; and the above-described electrolyte.

The negative electrode includes a negative electrode current collector; and a negative electrode active material layer on at least one surface of the negative electrode current collector, and the negative electrode active material layer includes a negative electrode active material, a conductive material and a binder.

Specifically, the negative electrode may be manufactured by coating a negative electrode slurry on one or two surfaces of the long sheet-shaped negative electrode current collector, drying the negative electrode slurry to remove the solvent and rolling, wherein the negative electrode slurry contains the negative electrode active material, the conductive material and the binder dissolved in the solvent. Meanwhile, the negative electrode including a non-coated region may be manufactured by coating the negative electrode slurry in a manner that the negative electrode slurry is not coated on a portion of the negative electrode current collector, for example, an end portion of the negative electrode current collector.

The negative electrode active material may include a material capable of reversible intercalation or deintercalation of lithium (Li⁺), a material capable of reversibly forming a lithium containing compound by reaction with lithium ions, a lithium metal or a lithium alloy. The material capable of reversible intercalation or deintercalation of lithium ions may include, for example, crystalline carbon, amorphous carbon or a mixture thereof, and specifically, artificial graphite, natural graphite, graphitizable carbon fibers, amorphous carbon, soft carbon and hard carbon, but is not limited thereto. The material capable of reversibly forming the lithium containing compound by reaction with lithium ions may include, for example, tin oxide, titanium nitrate or silicon-based compounds. The lithium alloy may include, for example, alloys of lithium (Li) and metal selected from the group consisting of sodium (Na), potassium (K), rubidium (Rb), cesium (Cs), francium (Fr), beryllium (Be), magnesium (Mg), calcium (Ca), strontium (Sr), barium (Ba), radium (Ra), aluminum (Al) and tin (Sn). Preferably, the negative electrode active material may be a lithium metal, and specifically, may be in the form of a lithium metal foil or a lithium metal powder. The silicon-based negative electrode active material may include Si, Si-Me alloys (where Me is at least one selected from the group consisting of Al, Sn, Mg, Cu, Fe, Pb, Zn, Mn, Cr, Ti, and Ni), SiO_{y}(where 0<y<2), Si—C composites or a combination thereof, and preferably SiO_{y} (where 0<y<2). Since the silicon-based negative electrode active material has high theoretical capacity, when the silicon-based negative electrode active material is included, it may be possible to improve capacity characteristics.

The negative electrode current collector may include negative electrode current collectors commonly used in the corresponding technical field, and may include, for example, copper, stainless steel, aluminum, nickel, titanium, sintered carbon, copper or stainless steel treated with carbon, nickel, titanium or silver on the surface, and aluminum-cadmium alloys. The negative electrode current collector may be typically 3 to 500 μm in thickness, and may have microtexture on the surface to enhance the bonding strength of the negative electrode active material. For example, the negative electrode current collector may come in various forms, for example, a film, a sheet, a foil, a net, a porous body, a foam, a nonwoven, etc.

The conductive material may be used to provide conductive properties to the negative electrode, and may include, without limitation, any conductive material having the ability to conduct electrons without causing any chemical change in the corresponding battery. Specific examples may include graphite such as natural graphite or artificial graphite: carbon-based materials such as carbon black, acetylene black, Ketjen black, channel black, furnace black, lamp black, thermal black, carbon fibers, carbon nanotubes, etc.: metal powder or metal fibers such as copper, nickel, aluminum, silver, etc.: conductive whiskers such as zinc oxide, potassium titanate, etc.: conductive metal oxide such as titanium oxide, etc.: or conductive polymer such as polyphenylene derivatives, etc., used either singly or in combination. The conductive material may be typically included in an amount of from 1 to 30 wt %, from 1 to 20 wt %, or from 1 to 10 wt % based on the total weight of the negative electrode active material layer.

The binder resin plays a role in attaching the negative electrode active material particles to each other and improving the adhesion strength between the negative electrode active material and the negative electrode current collector. Specific examples may include polyvinylidene fluoride (PVDF), a vinylidene fluoride-hexafluoropropylene copolymer (PVDF-co-HFP), polyvinylalcohol, polyacrylonitrile, carboxymethylcellulose (CMC), starch, hydroxypropylcellulose, regenerated cellulose, polyvinylpyrrolidone, polytetrafluoroethylene, polyethylene, polypropylene, ethylene-propylene-diene monomer rubber (EPDM rubber), sulfonated-EPDM, styrene-butadiene rubber (SBR), fluoro rubber, or a variety of copolymers thereof, used either singly or in combination. The binder may be included in an amount of from 1 to 30 wt %, from 1 to 20 wt %, or from 1 to 10 wt % based on the total weight of the negative electrode active material layer.

The positive electrode can include a positive electrode current collector; and a positive electrode active material layer on at least one surface of the positive electrode current collector, and the positive electrode active material layer includes a positive electrode active material, and may further include a conductive material, a binder, an additive, etc.

The positive electrode current collector is configured to support the positive electrode active material as described in the current collector that supports the negative electrode. For example, the positive electrode current collector may copper, stainless steel, aluminum, nickel, titanium, palladium, sintered carbon, copper or stainless steel treated with carbon, nickel or silver on the surface, aluminum-cadmium alloys, etc.

The positive electrode active material may include at least one selected from the group consisting of sulfur, especially elemental sulfur (S8) and a sulfur compound. The positive electrode active material may include at least one selected from the group consisting of inorganic sulfur, Li₂Sn (n≥1), disulfide compounds, organic sulfur compounds and carbon-sulfur polymer ((C₂Sₓ)n, x=2.5 to 50, n≥2). Specifically, the positive electrode active material may include inorganic sulfur.

As sulfur included in the positive electrode active material does not have electrical conductivity itself, sulfur is used in combination with conductive materials such as carbon materials. Accordingly, sulfur may be included in the form of a sulfur-carbon composite, and preferably the positive electrode active material may be a sulfur-carbon composite.

The carbon included in the sulfur-carbon composite may be a porous carbon material that provides skeletons for uniformly and stably immobilizing sulfur and compensates for low electrical conductivity of sulfur to enhance electrochemical reaction.

The porous carbon material may be generally produced by carbonization of a variety of carbonaceous precursors. The porous carbon material may include irregular pores therein. The average diameter of the pores may be in a range between 1 and 200 nm, and the porosity may be in a range between 10 and 90% of the total volume of the porous carbon material. When the average diameter of the pores is less than the aforementioned range, the pore size is at molecular level, making sulfur loading impossible. In contrast, when the average diameter of the pores is more than the aforementioned range, it is not suitable for an electrode manufacturing process due to low mechanical strength of the porous carbon material.

The porous carbon material may be spherical, rod-like, spiky, platy, tubular or bulky in shape, and may be in any shape commonly used in lithium-sulfur batteries without limitation.

The porous carbon material may have a pore structure or large specific surface area and include any porous carbon material commonly used in the art. For example, the porous carbon material may include graphite: graphene: carbon black such as Denka black, acetylene black, Ketjen black, channel black, furnace black, lamp black, thermal black, etc.; carbon nanotubes (CNT) such as single-walled carbon nanotubes (SWCNT) and multi-walled carbon nanotubes (MWCNT): carbon fibers such as graphite nanofibers (GNF), carbon nanofibers (CNF), activated carbon fibers (ACF), etc.: graphite such as natural graphite, artificial graphite, expandable graphite, etc., activated carbon, etc. Preferably, the porous carbon material may be carbon nanotubes.

The sulfur-carbon composite may include sulfur in an amount of from 60 to 90 parts by weight, preferably from 65 to 85 parts by weight, and more preferably from 70 to 80 parts by weight based on 100 parts by weight of the sulfur-carbon composite. When the amount of sulfur is less than the aforementioned range, the amount of the porous carbon material in the sulfur-carbon composite is higher, the specific surface area increases, and the binder content to the sulfur content may increase when manufacturing the positive electrode. The use of the binder in a higher amount may eventually increase the surface resistance of the positive electrode and may prevent the passage of electrons like an insulator, resulting in performance degradation of the battery. On the contrary, when the amount of sulfur is more than the aforementioned range, unbonded sulfur may form an agglomerate or re-deposition on the porous carbon material surface may occur, which can make it difficult to accept electrons and may cause it to fail to participate in electrochemical reaction, resulting in battery capacity reduction.

Additionally, in the sulfur-carbon composite, sulfur may be disposed on at least one of the inner surface or the outer surface of the porous carbon material, and in this instance, sulfur may be present in an area of less than 100%, 1 to 95%, or 60 to 90% of the entire inner and outer surface of the porous carbon material. When sulfur is present in the inner surface and the outer surface of the porous carbon material within the aforementioned range, maximum effect may be exhibited in terms of electron transport area and electrolyte wetting. Specifically, as sulfur is thinly and uniformly loaded onto the inner and outer surface of the porous carbon material in the aforementioned range, it may be possible to increase the electron transport contact area during charging and discharging. When sulfur is disposed in an area corresponding to 100% of the entire inner and outer surface of the porous carbon material, the carbon material may be completely covered with sulfur, resulting in poor electrolyte wetting and little or no contact with the electrically conductive material, and may thereby fail to accept electrons at the electrode and participate in electrochemical reaction.

A method for manufacturing the sulfur-carbon composite is not particularly limited in the present disclosure, and may include any method commonly used in the art. For example, the composite may be formed by simply mixing sulfur with the porous carbon material and thermally treating the mixture.

In addition to the above-described components, the positive electrode active material may further include at least one type of additive selected from transition metal elements, Group IIIA elements, Group IVA elements, compounds of these elements with sulfur and alloys of these elements with sulfur.

The transition metal elements may include Sc, Ti, V, Cr, Mn, Fe, Co, Ni, Cu, Zn, Y, Zr, Nb, Mo, Tc, Ru, Rh, Pd, Os, Ir, Pt, Au, Hg, etc., the Group IIIA elements may include Al, Ga, In, Tl, etc., and the Group IVA elements may include Ge, Sn, Pb, etc.

The sulfur may be included in an amount of from 40 to 95 wt %, preferably from 50 to 90 wt %, and more preferably from 60 to 85 wt % based on 100 wt % of the positive electrode active material layer of the positive electrode. In an embodiment of the present disclosure, when the sulfur-carbon composite is used as the positive electrode active material, the sulfur-carbon composite may be included in an amount of from 90 wt % to 97 wt % based on 100 wt % of the positive electrode active material layer. When the amount of the positive electrode active material is less than the aforementioned range, it may be difficult to achieve sufficient electrochemical reaction of the positive electrode. On the contrary, when the amount of the positive electrode active material is more than the aforementioned range, the amounts of the conductive material and the binder as described below are lower, the resistance of the positive electrode may increase, and the physical properties of the positive electrode may decrease.

Optionally, the positive electrode active material layer may further include the conductive material to allow electrons to smoothly move in the positive electrode (specifically, the positive electrode active material) and the binder to attach the positive electrode active material to the current collector.

The conductive material is a material that acts as a movement passage of electrons from the current collector to the positive electrode active material by electrically connecting the electrolyte to the positive electrode active material. The conductive material may include any material having electrical conductivity without limitation.

For example, the conductive material may include graphite such as natural graphite, artificial graphite, etc.; carbon black such as Super-P, Denka black, acetylene black, Ketjen black, channel black, furnace black, lamp black, thermal black, etc.: carbon derivatives such as carbon nanotubes and fullerene: electrically conductive fibers such as carbon fibers and metal fibers: fluoro carbon: metal powder such as aluminum powder and nickel powder: or electrically conductive polymer such as polyaniline, polythiophene, polyacetylene and polypyrrole, used singly or in combination.

The conductive material may be included in an amount of from 0.01 to 30 wt % based on 100 wt % of the positive electrode active material layer of the positive electrode. When the amount of the conductive material is less than the aforementioned range, it may result in poor electron transfer between the positive electrode active material and the current collector, inducing reductions in voltage and capacity. On the contrary, when the amount of the conductive material is more than the aforementioned range, the proportion of the positive electrode active material may be lower and the total energy (the amount of charges) of the battery may be reduced. Accordingly, it may be preferable to determine an optimum amount of the conductive material in the aforementioned range.

The binder can play a role in binding the positive electrode active material to the positive electrode current collector and interconnecting the positive electrode active material to increase the bond strength, and may include any known binder.

For example, the binder can include a fluororesin-based binder including polyvinylidene fluoride (PVdF) or polytetrafluoroethylene (PTFE); a rubber-based binder including styrene butadiene rubber (SBR), acrylonitrile-butadiene rubber and styrene-isoprene rubber: a cellulose-based binder including carboxymethylcellulose (CMC), starch, hydroxypropylcellulose and regenerated cellulose: a polyalcohol-based binder; a polyolefin-based binder including polyethylene and polypropylene: a polyimide-based binder; a polyester-based binder; and a silane-based binder, or a mixture thereof or a copolymer thereof.

The binder may be included in an amount of from 0.5 to 30 wt % based on 100 wt % of the positive electrode active material layer of the positive electrode. When the amount of the binder is less than 0.5 wt %, the properties of the positive electrode may decrease and the positive electrode active material and the conductive material may be desorbed. When the amount of the binder is more than the aforementioned range, the ratio of the positive electrode active material and the conductive material in the positive electrode is lower and the capacity of the battery may reduce. Accordingly, it may be preferable to determine an optimum amount of the binder in the aforementioned range.

The separator may separate the negative electrode from the positive electrode and provide a movement passage of lithium ions, and may include, without limitation, any type of separator commonly used in lithium secondary batteries. Specifically, the separator may include a porous polymer film, for example, a porous polymer film made of a polyolefin-based polymer such as an ethylene homopolymer, a propylene homopolymer, an ethylene/butene copolymer, an ethylene/hexene copolymer and an ethylene/methacrylate copolymer or a stack structure of two or more layers of them. Additionally, commonly used porous nonwoven fabrics, for example, nonwoven fabrics made of high melting point glass fibers, polyethyleneterephthalate fibers, etc. may be used. Additionally, coated separators including ceramics or polymer materials may be used to ensure heat resistance or mechanical strength.

The lithium-sulfur battery is not limited to a particular shape and may come in various shapes, for example, a cylindrical type, a stack type, a coin type and so on.

Additionally, aspects of the present disclosure provide a battery module including the lithium-sulfur battery as a unit battery. The battery module may be used as a source of power for medium- and large-scale devices that require high temperature stability, long cycle characteristics and high capacity characteristics.

Examples of the medium- and large-scale devices may include devices that work using power produced by electric motors such as power tools; electric cars including electric vehicles (EV), hybrid electric vehicles (HEV), plug-in hybrid electric vehicles (PHEV), etc.; electric two-wheeled vehicles including E-bikes and E-scooters: electric golf carts; and energy storage systems, but is not limited thereto.

Hereinafter, aspects of the present disclosure will be described in detail through embodiments/examples. However, the embodiments/examples according to the present disclosure may be modified in many other forms, and the scope of the present disclosure should not be interpreted as being limited to the embodiments/examples described below. The embodiments/examples of the present disclosure are provided to describe the present disclosure to those skilled in the art thoroughly and completely.

### Examples 1 to 12 and Comparative Examples 1 to 5

### Preparation of Electrolyte

An electrolyte including a solvent, a nonsolvent and a lithium salt was prepared to meet the SVR factor value, the MR factor value and the amount of LiI specified in Table 1 below.

In this instance, 2-methyl tetrahydrofuran (2MeTHF), ethyleneglycolethylether (EGDEE), tetrahydrofuran (THF), tetrahydropyran (THP), dimethylether (DME) or a mixture thereof was used as the solvent, 1,1,2,2-tetrafluoroethyl 2,2,3,3-tetrafluoropropylether used (TTE) was as the nonsolvent, and lithium bis(fluorosulfonyl)imide (LiFSI), lithium bis(trifluoromethanesulfonyl)imide (LiTFSI) and LiI were used as the lithium salt.

### Manufacture of Positive Electrode

90 parts by weight of a sulfur-carbon composite (S:C=75:25 weight ratio) as a positive electrode active material (an amount of sulfur alone was set to 67.5 wt % based on the total weight of the positive electrode, and activated carbon having a pore volume of 1.8 cm³/g was used as a carbon material), 5 parts by weight of Denka black as a conductive material, and 5 parts by weight of styrene butadiene rubber/carboxymethyl cellulose (SBR: CMC=7:3 (weight ratio)) as a binder were mixed to prepare a positive electrode slurry composition, and the slurry composition was coated on a current collector (an Al foil), dried at 50° C. for 12 hours and compressed using a roll press machine to manufacture a positive electrode (In this instance, the loading was 3.5 mAh/cm², and the porosity of the electrode was 65%).

### Manufacture of Lithium-Sulfur Battery

The as-prepared positive electrode and a 150 μm thick lithium metal negative electrode were placed with a polyethylene (PE) separator interposed between them, and the prepared electrolyte was injected to manufacture a coin cell-type lithium-sulfur battery. On the other hand, in the manufacture of the battery, the positive electrode was punched into a 14phi circular electrode, the polyethylene separator was punched into 19phi, and the lithium metal was punched into 16phi. Additionally, the battery was manufactured using a sparing solvating electrolyte (SSE) electrolyte system.

TABLE 1

| | | | | Amount of LiI | |
|---|---|---|---|---|---|
| | Composition of | | | (parts by weight | |
| | solvent and | | | based on 100 | |
| | nonsolvent | SVR | MR | parts by weight | Life |
| | (volume | factor | factor | of total | evaluation |
| | ratio) | value | value | electrolyte) | (cycle) |
| Example 1 | 2MeTHF:EGDEE:TTE | 0.43 | 1.48 | 1 | 247 |
| | (2:1:7) | | | | |
| Example 2 | 2MeTHF:EGDEE:TTE | 0.43 | 1.33 | 1 | 215 |
| | (1.5:1.5:7) | | | | |
| Example 3 | 2MeTHF:EGDEE:TTE | 0.43 | 1.11 | 1 | 237 |
| | (1:2:7) | | | | |
| Example 4 | 2MeTHF:EGDEE:TTE | 0.43 | 1.04 | 2 | 307 |
| | (1:2:7) | | | | |
| Example 5 | THP:EGDEE:TTE | 0.43 | 1.2 | 2 | 264 |
| | (1:2:7) | | | | |
| Example 6 | DME:TTE (3:7) | 0.43 | 1.64 | 0.1 | 96 |
| Example 7 | DME:TTE (3:7) | 0.43 | 1.52 | 1 | 122 |
| Example 8 | THF:DME:TTE | 0.43 | 1.74 | 1 | 137 |
| | (1.5:1.5:7) | | | | |
| Example 9 | THF:DME:TTE | 0.43 | 1.61 | 2 | 143 |
| | (1.5:1.5:7) | | | | |
| Example 10 | THP:DME:TTE | 0.43 | 1.54 | 1 | 146 |
| | (0.5:2.5:7) | | | | |
| Example 11 | 2MeTHF:DME:TTE | 0.43 | 1.53 | 1 | 145 |
| | (0.5:2.5:7) | | | | |
| Example 12 | 2MeTHF:DME:EGDEE:TTE | 0.67 | 1.62 | 1 | 147 |
| | (1.5:1:1.5:6) | | | | |
| Comparative | DME:TTE(3:7) | 0.43 | 1.65 | — | 85 |
| Example 1 | | | | | |
| Comparative | THF:TTE(2:8) | 0.25 | 1.9 | — | 79 |
| Example 2 | | | | | |
| Comparative | DME:TTE(3:7) | 0.43 | 2.58 | 1 | 45 |
| Example 3 | | | | | |
| Comparative | EGDEE:TTE(3:7) | 0.43 | 1.43 | — | 28 |
| Example 4 | | | | | |
| Comparative | EGDEE:TTE(3:7) | 0.43 | 0.71 | — | 7 |
| Example 5 | | | | | |

### Life Evaluation

To determine the life characteristics of the lithium-sulfur secondary batteries prepared in Examples and Comparative Examples, the life cycle at the time when the capacity retention of the lithium-sulfur secondary battery is 80% was measured while repeatedly discharging and charging with 0.1 C current density 2.5 times, then charging with 0.2 C current density and discharging with 0.5C current density for 150 cycles.

1. An electrolyte for a lithium-sulfur secondary battery, comprising:
a solvent, a nonsolvent and lithium salts that include at least two lithium salt types,
wherein the lithium salts include LiI,
wherein a Solvent Volume Ratio (SVR) factor value of the solvent and the nonsolvent is from 0.2 to 0.7, and the SVR factor value is represented by the following Equation 1, and
wherein a Molar mass Ratio (MR) factor value of the solvent and the lithium salts is from 0.75 to 1.85, and the MR factor value is represented by the following Equation 2,
$$S V R factor = volume of the solvent \div volume of the nonsolvent \qquad [ Equation 1 ]$$
$$M R factor = Number of moles of the solvent \div ( Number of moles of the lithium salts excluding the LiI ) \qquad [ Equation 2 ]$$

2. The electrolyte for the lithium-sulfur secondary battery according to claim 1, wherein the SVR factor value is from 0.3 to 0.65.

3. The electrolyte for the lithium-sulfur secondary battery according to claim 1, wherein the MR factor value is from 1.0 to 1.75.

4. The electrolyte for the lithium-sulfur secondary battery according to claim 1, wherein the solvent has a solubility of 0.1M or more for the lithium salts, and
wherein the nonsolvent has a solubility of less than 0.1M for the lithium salts.

5. The electrolyte for the lithium-sulfur secondary battery according to claim 4, wherein the solvent includes a linear ether, a cyclic ether or a mixture thereof.

6. The electrolyte for the lithium-sulfur secondary battery according to claim 4, wherein the solvent includes a mixture of a linear ether and a cyclic ether.

7. The electrolyte for the lithium-sulfur secondary battery according to claim 4, wherein the nonsolvent includes a fluorinated ether.

8. The electrolyte for the lithium-sulfur secondary battery according to claim 1, wherein the lithium salts include lithium bis(fluorosulfonyl)imide (LiFSI), lithium bis(trifluoromethanesulfonyl)imide (LiTFSI) and LiI.

9. The electrolyte for the lithium-sulfur secondary battery according to claim 1, wherein an amount of the LiI is from 0.1 to 3.0 parts by weight based on total 100 parts by weight of the electrolyte for the lithium-sulfur secondary battery.

10. The electrolyte for the lithium-sulfur secondary battery according to claim 8, wherein the amount of the LiI is from 0.35 to 15 parts by weight based on total 100 parts by weight of the lithium salts.

11. The electrolyte for the lithium-sulfur secondary battery according to claim 1, wherein the electrolyte for the lithium-sulfur secondary battery does not include any of a nitrate-based compound or a nitrite-based compound.

12. A lithium-sulfur secondary battery comprising:
a negative electrode; a positive electrode; a separator; and the electrolyte according to claim 1.
